(19) United States
(12) Patent Application Publication
(10) Pub. No.: US 2006/0017963 A1
(43) Pub. Date: Jan. 26, 2006

(54) Media conversion apparatus, network type direct output system, and method for output process instruction transfer

(75) Inventors: Kenji Sakuda, Nagano (JP); Hideki Morozumi, Nagano (JP); Yoshinao Kitahara, Nagano (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/050,448

(22) Filed: Feb. 4, 2005

(30) Foreign Application Priority Data
Feb. 4, 2004 (JP) P2004-028191

(51) Int. Cl. G06F 15/00

(52) U.S. Cl. 358/1.15

(57) ABSTRACT

To allow an image feed unit for outputting an output process instruction to an image output unit according to one-to-one direct connection to output an image from a network type image output unit. One-to-one communication means 104 is connected to an image feed unit 1 capable of being connected directly to an image output unit 6 by one-to-one correspondence. Network communication means 105 is connected to a plurality of network type image output units 3 capable of performing an output process based on an output process instruction via a network 5. Receiving means 134 receives an output process instruction from the image feed unit 1 via the one-to-one communication means 104. Transferring means 143 selects one from a plurality of the network type image output units 3, and then transmits the output process instruction received by the receiving means 134 to the selected network type image output unit 3 via the network communication means 105.

### BACKGROUND OF THE INVENTION

1. Field of the Invention

The invention relates to a media conversion apparatus, a network type direct output system, and a method for output process instruction transfer which allow image data saved in an image feed unit such as a digital still camera to be outputted from an image output unit or recorded into an image recording unit.

2. Related Art

Patent Document 1 discloses a system in which a digital camera serving as a USB storage class device and a printer serving as a USB host are connected directly by USB (Universal Serial Bus). In this system, in response to a button operation, the camera generates a printer status request, a printing request, a printing stop request, or the like to the printer in the form of a file. The camera then writes the request into a memory in the camera. The printer checks the memory in the camera periodically at a high rate. When finding a file of a request, the printer reads the file and performs a requested operation.

[Patent Document 1] Japanese Published Unexamined Patent Application No. 2003-259274 (Drawings and Detailed Description of the Invention)

In such a prior art system, a digital camera and a printer are connected directly by USB, so that an image saved in the digital camera can be printed out by the printer without intervention of a computer. Digital cameras and the like capable of being connected directly to a printer by USB in the above-mentioned manner are already available on the market.

As for such a system configuration that allows a printing process to be performed without intervention of a computer, in addition to the above-mentioned prior art configuration that a digital still camera and a printer are connected directly by one-to-one correspondence, a configuration is also possible where a digital still camera and a printer are connected via a network.

Nevertheless, digital still cameras presently available on the market support a printing process according to one-to-one direct connection solely. Thus, such a digital still camera presently available on the market cannot be connected to a printer via a network. That is, images saved in such a digital still camera supporting solely one-to-one direct connection cannot be printed out by a network type printer via a network.

### SUMMARY OF THE INVENTION

The invention has been devised while considering the above-mentioned problem. An object of the invention is to provide a media conversion apparatus, a network type direct output system, and a method for output process instruction transfer which allow an image feed unit such as a digital still camera for outputting an output process instruction to an image output unit such as a printer according to one-to-one direct connection to output an image through a network type image output unit.

An object of another invention of the present application is to provide a media conversion apparatus which allows an image feed unit such as a digital still camera for outputting a save process instruction to an image storage unit such as a storage device according to one-to-one direct connection to save image data into a network type image save unit.

[Means for Solving the Object]

A media conversion apparatus according to the invention comprises: one-to-one communication means connected to an image feed unit capable of being connected directly to an image output unit by one-to-one correspondence; receiving means for receiving via the one-to-one communication means an output process instruction outputted from the image feed unit for causing the image output unit to perform a desired output; network communication means connected to a plurality of network type image output units capable of performing via a network an output process based on the output process instruction; and transferring means for selecting one from a plurality of the network type image output units and then transmitting the output process instruction received by the receiving means to the selected network type image output unit via the network communication means.

According to this configuration, when an image feed unit for outputting an output process instruction to an image output unit according to one-to-one direct connection is connected to a media conversion apparatus, an image in an image data file saved in this image feed unit can be outputted by any one of the network type image output units. This allows the image feed unit for outputting an output process instruction to an image output unit according to one-to-one direct connection to transmit the output process instruction to the network type image output unit so as to cause the network type image output unit to output the image.

In addition to the above-mentioned configuration of the invention, in a media conversion apparatus according to the invention, the transferring means compares an output process instruction received by the receiving means with information concerning output capability of a plurality of the network type image output units connected to the network communication means, then selects a network type image output unit from a plurality of the network type image output units, and then transmits the output process instruction received by the receiving means to the selected network type image output unit.

According to this configuration, in response to an output process instruction received by the receiving means, the most suitable network type image output unit is selected for executing the output process instruction.

In addition to the above-mentioned configuration of the invention, in a media conversion apparatus according to the invention, the transferring means collects the information concerning the output capability of a plurality of the network type image output units in advance, then generates a list of the information, and then selects one network type image output unit from the list when the receiving means receives an output process instruction.

According to this configuration, the information of each image output unit is collected in the list in advance. This permits rapid selection of an image output unit.

In addition to the above-mentioned configuration of the invention, in a media conversion apparatus according to the invention, in the list, order of priority depending on output conditions is assigned to a plurality of the network type image output units, so that the transferring means selects one having the highest order of priority from a plurality of network type image output units having an output condition which is most suitable to an output process instruction received by the receiving means.

According to this configuration, even in a case where a plurality of network type image output units are suitable for executing the output process instruction, the most suitable one having the highest order of priority is selected.

In addition to the above-mentioned configuration of the invention, in a media conversion apparatus according to the invention, the order of priority can be changed by an input device of the image feed unit, a computer connected to the network, or an input device of the media conversion apparatus.

According to this configuration, the order of priority can be set up appropriately, for example, according to the configuration and the performance of the image feed unit and the image output units.

In addition to the above-mentioned configuration of the invention, in a media conversion apparatus according to the invention, on the basis of the information concerning the output capability of each network type image output unit, from a plurality of the network type image output units, the transferring means selects one expected to process at the highest speed an output process instruction received by the receiving means, one purchased from the same vendor as that of the image feed unit, one used by the same user as that of the image feed unit, or one having the shortest output process time in the past.

This configuration realizes: the shortest output time in the image output unit; quality outputting based on the use of units of the same vendor; output processing where the convenience and the privacy of individual persons are secured; or the shortest overall output process time including the communication time.

A network type direct output system according to the invention comprises: a media conversion apparatus according to any one of the descriptions given above; an image feed unit connected to the one-to-one communication means of the media conversion apparatus and transmitting to the one-to-one communication means an output process instruction for causing an image output unit connected directly to the image feed unit by one-to-one correspondence to perform a desired output; and a network type image output unit connected to the network communication means of the media conversion apparatus via a network and performing an output process of the output process instruction transmitted from the image feed unit via the media conversion apparatus.

According to this configuration, in response to an output process instruction of the image feed unit for outputting an output process instruction to an image output unit according to one-to-one direct connection, an image in an image data file saved in this image feed unit can be outputted by any one of the network type image output units connected via the network. This allows the image feed unit for outputting an output process instruction to an image output unit according to one-to-one direct connection to transmit the output process instruction to the network type image output unit so as to cause the network type image output unit to output the image.

A method for output process instruction transfer according to the invention comprises the steps of: receiving an output process instruction transmitted for causing an image output unit to perform a desired output from an image feed unit capable of being connected directly to the image output unit by one-to-one correspondence; selecting one from a plurality of network type image output units connected via a network and capable of performing an output process based on the output process instruction; and transmitting to the selected network type image output unit the output process instruction received from the image feed unit.

According to this method, an output process instruction of the image feed unit for outputting an output process instruction to an image output unit according to one-to-one direct connection can be transmitted to any one of the network type image output units connected via the network. This allows the image feed unit for outputting an output process instruction to an image output unit according to one-to-one direct connection to transmit the output process instruction to the network type image output unit so as to cause the network type image output unit to output the image.

A media conversion apparatus according to another invention of the present application comprises: one-to-one communication means connected to an image feed unit capable of being connected directly to an image storage unit by one-to-one correspondence; receiving means for receiving via the one-to-one communication means a save process instruction outputted from the image feed unit for causing the image storage unit to perform a desired save; network communication means connected to a plurality of network type image storage units capable of performing via a network a save process based on the save process instruction; and transferring means for selecting one from a plurality of the network type image storage units and then transmitting a save process instruction received by the receiving means to the selected network type image storage unit via the network communication means.

According to this configuration, when an image feed unit for outputting a save process instruction to an image storage unit according to one-to-one direct connection is connected to a media conversion apparatus, an image data file saved in this image feed unit can be transferred to and saved in a network type image storage unit. This allows the image feed unit for outputting a save process instruction to an image storage unit according to one-to-one direct connection to transmit the save process instruction to the network type image storage unit so as to cause the network type image storage unit to perform a save process for image data.

The invention allows an image feed unit for outputting an output process instruction to an image output unit according to one-to-one direct connection to cause a network type image output unit to output an image.

Another invention of the present application allows an image feed unit for outputting a save process instruction to an image storage unit according to one-to-one direct connection to cause a network type image save unit to save image data.

### BRIEF DESCRIPTION OF THE DRAWINGS

FIG. 1 is a configuration diagram showing a network type direct printing system according to an embodiment of the invention.

FIG. 2 is a block diagram showing the hardware configuration of a DSC of FIG. 1 which supports direct printing based on one-to-one direct connection.

FIG. 3 is a diagram showing the storage contents of a flash memory of FIG. 2.

FIG. 4 is a diagram showing the storage contents of a removable memory of FIG. 2.

FIG. 5 is a configuration diagram showing a state that a DSC of FIG. 1 which supports direct printing based on one-to-one direct connection and the printer which supports direct printing based on one-to-one direct connection are connected by one-to-one correspondence through a USB cable.

FIG. 6 is a block diagram showing the hardware configuration of a printer of FIG. 5 which supports direct printing based on one-to-one direct connection.

FIG. 7 is a diagram showing the storage contents of a memory of FIG. 6.

FIG. 8 is a diagram showing the stack structure of a communication protocol embodied in the state of one-to-one connection of FIG. 5, the power of a DSC which supports direct printing based on one-to-one direct connection and the power of a printer which supports direct printing based on one-to-one direct connection are turned ON.

FIG. 9 is a diagram showing an example of a start print request generated by a print client.

FIG. 10 is a block diagram showing the hardware configuration of a printer which supports direct printing based on network connection in a network type direct printing system of FIG. 1.

FIG. 11 is a diagram showing the storage contents of a memory of FIG. 10.

FIG. 12 is a block diagram showing the hardware configuration of a media conversion apparatus in a network type direct printing system of FIG. 1.

FIG. 13 is a diagram showing the storage contents of a non-volatile memory of FIG. 12.

FIG. 14 is a diagram showing the stack structure of a communication protocol embodied in the connection state of FIG. 1, the power of a DSC which supports direct printing based on one-to-one direct connection, the power of a media conversion apparatus, and the power of a printer which supports network type direct printing are turned ON.

FIG. 15 is a diagram showing a printing process sequence of an entire network type direct printing system.

### DETAILED DESCRIPTION OF THE PREFERRED EMBODIMENTS

A media conversion apparatus, a network type direct output system, and a method for output process instruction transfer according to embodiments of the invention are described below with reference to the drawings. The network type direct output system is described for an exemplary case of a network type direct printing system. The method for output process instruction transfer is described for an exemplary case of a printing process instruction as a part of the operation of the network type direct printing system.

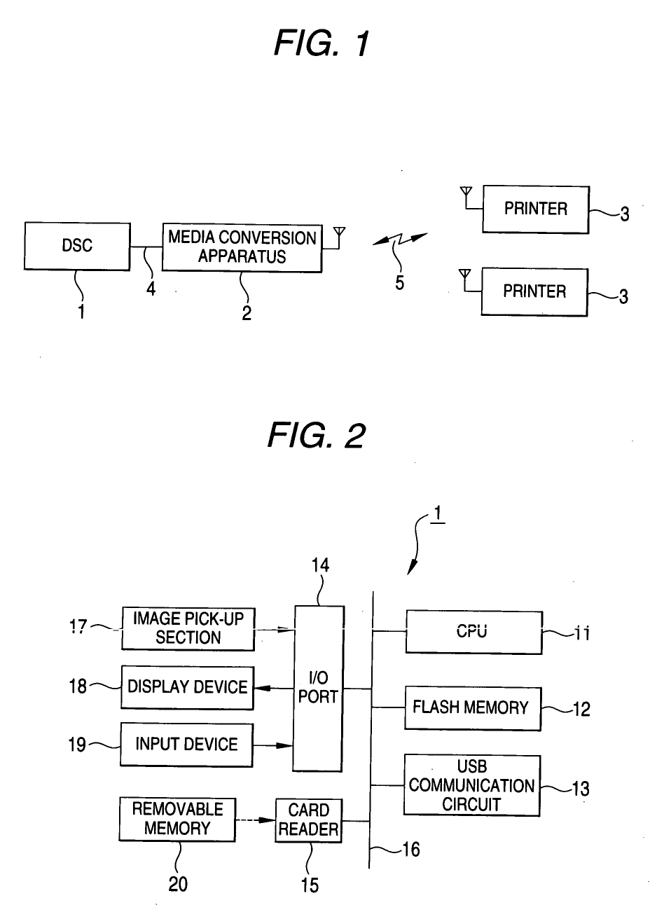

FIG. 1 is a configuration diagram showing a network type direct printing system according to an embodiment of the invention. The network type direct printing system comprises: a digital still camera (DSC) 1 serving as an image feed unit which supports direct printing based on one-to-one direct connection; a media conversion apparatus 2; and a plurality of printers 3 each serving as a network type image output unit which supports direct printing based on network connection. In this network type direct printing system, a single printer 3 may be used solely.

The DSC 1 and the media conversion apparatus 2 are directly connected using a USB cable 4.

The media conversion apparatus 2 and a plurality of the printers 3 are connected by a wireless LAN (Local Area Network) 5 serving as a network. Such a connection where a media conversion apparatus 2 and a plurality of printers 3 are connected by a wireless LAN 5 allows a network to be built, for example, in a house of an ordinary home where wiring is not preferred.

FIG. 2 is a block diagram showing the hardware configuration of a DSC 1 of FIG. 1 which supports direct printing based on one-to-one direct connection. The DSC 1 comprises: a central processing unit (CPU) 11 for executing a program; a flash memory 12; a USB communication circuit 13 serving as one-to-one communication means connected to the USB cable 4; an I/O (Input/Output) port 14; a card reader 15; and a bus 16 for interconnecting these. The I/O port 14 is connected to: an image pick-up section 17 for generating image data by means of image pick-up; a display device 18 for displaying various data and images; and an input device 19 for generating input data in response to an operation. A removable memory 20 composed of a semiconductor memory or the like is attached to and detached from the card reader 15.

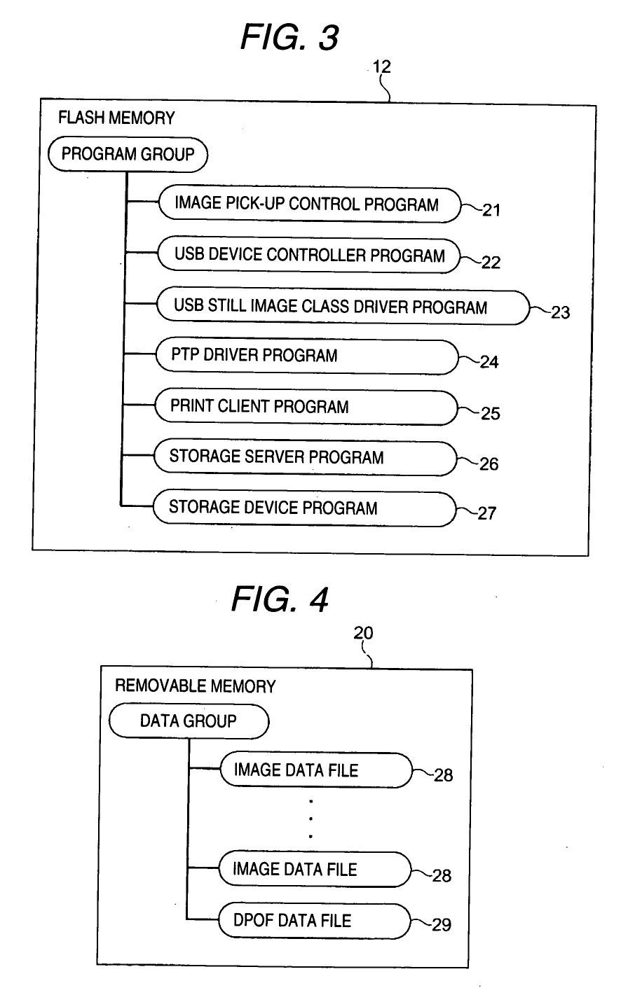

FIG. 3 is a diagram showing the storage contents of a flash memory 12 of FIG. 2. The flash memory 12 stores a program group. The program group of the flash memory 12 includes an image pick-up control program 21, a USB device controller program 22, a USB still image class driver program 23, a PTP (Picture Transfer Protocol) driver program 24, a print client program 25, a storage server program 26, and a storage device program 27.

The image pick-up control program 21 is executed by the central processing unit 11 so as to realize an image pick-up control section. The image pick-up control section controls the image pick-up section 17 so as to store image data acquired by the image pick-up section 17 into the removable memory 20 in the form of an image data file such as JPEG (Joint Photographic Expert Group) and EXIF (Exchangeable Image File Format).

The USB device controller program 22 is executed by the central processing unit 11 so as to realize a USB device controller. The USB device controller controls the transmission and the reception of communication data in the USB communication circuit 13.

The USB still image class driver program 23 is executed by the central processing unit 11 so as to realize a USB still image class driver. The still image class is one of the classes of USB, and is a class for transferring a still image through a USB cable 4. The USB still image class driver controls the communication of this still image according to the USB standard.

The PTP driver program 24 is executed by the central processing unit 11 so as to realize a PTP driver. The PTP is a protocol for transmitting image data from a DSC 1 to a printer 3. The PTP driver controls the transmission of this image data according to the PTP.

The print client program 25 is executed by the central processing unit 11 so as to realize a print client for transmitting and receiving a request and a response concerning the control of the progress of a printing process or the printing process itself. The storage server program 26 is executed by the central processing unit 11 so as to realize a storage server for transmitting and receiving a request and a response concerning the storage. The storage device program 27 is executed by the central processing unit 11 so as to realize a storage device for performing an input and output process for the storage.

FIG. 4 is a diagram showing the storage contents of a removable memory 20 of FIG. 2. The removable memory 20 stores a data group. The data group of the removable memory 20 includes a plurality of image data files 28. An image data file 28 contains one piece of image data. In the DSC 1, the image data files 28 contain image data generated by the image pick-up section 17. The image data files 28 have mutually different file names and file IDs (addresses).

The data group of the removable memory 20 may include a DPOF (Digital Print Order Format) data file 29. The DPOF data file 29 contains DPOF data. The DPOF data is data of a format having been set for the purpose of placing an order for the printing of image data to a D&P shop or the like. In this data, specified are: the file name of image data to be printed out; the size of a photographic paper sheet or the like to be used; the printing size of the image data; the layout of the image data; the number of print copies; and the like.

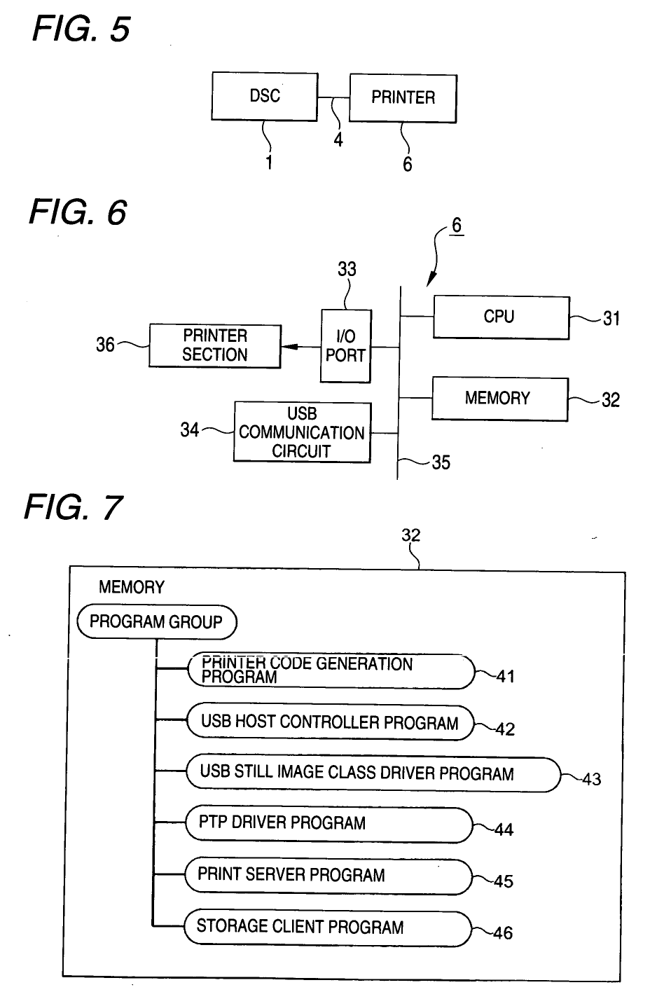

Described below is direct printing based on a one-to-one direct connection between the DSC 1 and a printer serving as an image output unit capable of one-to-one direct connection. FIG. 5 is a configuration diagram showing a state where a DSC 1 of FIG. 1 which supports direct printing based on one-to-one direct connection and a printer 6 which supports direct printing based on one-to-one direct connection are connected by one-to-one correspondence through a USB cable 4. As such, the DSC 1 of FIG. 1 which supports direct printing based on one-to-one direct connection can be connected directly to the printer 6 which supports direct printing based on one-to-one direct connection, using the USB cable 4.

FIG. 6 is a block diagram showing the hardware configuration of a printer 6 of FIG. 5 which supports direct printing based on one-to-one direct connection. The printer 6 comprises: a central processing unit 31; a memory 32; an I/O port 33; a USB communication circuit 34 connected to a USB cable 4; and a bus 35 for interconnecting these. The I/O port 33 is connected to a printer section 36 for performing a printing process onto paper, an OHP sheet, or the like according to a predetermined printer code.

FIG. 7 is a diagram showing the storage contents of a memory 32 of FIG. 6. The memory 32 stores a program group. The program group of the memory 32 includes a printer code generation program 41, a USB host controller program 42, a USB still image class driver program 43, a PTP driver program 44, a print server program 45, and a storage client program 46.

The printer code generation program 41 is executed by the central processing unit 31 so as to realize a printer code generation section. On the basis of image data and its print setting information, the printer code generation section generates a printer code called an ESC/P (Epson Standard Code/Page) command, or the like. This printer code is outputted through the I/O port 33 to the printer section 36.

The USB host controller program 42 is executed by the central processing unit 31 so as to realize a USB host controller. The USB host controller controls the transmission and the reception of communication data in the USB communication circuit 34.

The USB still image class driver program 43 is executed by the central processing unit 31 so as to realize a USB still image class driver. The PTP driver program 44 is executed by the central processing unit 31 so as to realize a PTP driver.

The print server program 45 is executed by the central processing unit 31 so as to realize a print server for transmitting and receiving a request and a response concerning the control of the progress of a printing process or the printing process itself. The storage client program 46 is executed by the central processing unit 31 so as to realize a storage client for transmitting and receiving a request and a response concerning the storage.

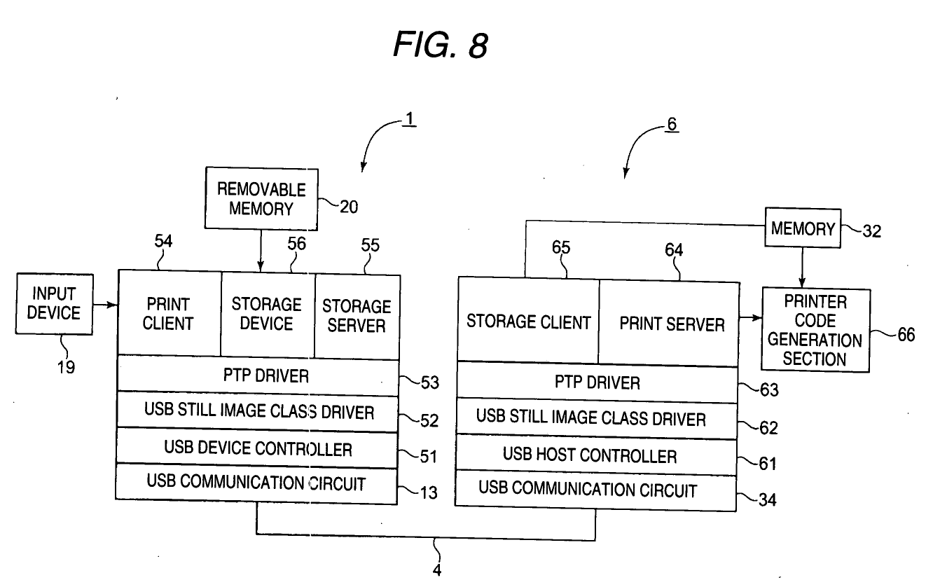

FIG. 8 is a diagram showing the stack structure of a communication protocol embodied in the state of one-to-one connection of FIG. 5, the power of a DSC 1 which supports direct printing based on one-to-one direct connection and the power of a printer 6 which supports direct printing based on one-to-one direct connection are turned ON.

In the DSC 1 which supports direct printing based on one-to-one direct connection, a USB device controller 51 serving as a data link layer, a USB still image class driver 52 serving as a network layer, and a PTP driver 53 serving as a transport layer are present above the USB communication circuit 13 serving as a physical layer. Further, a print client 54, a storage server 55, and a storage device 56 which serve as an application layer are present above the PTP driver 53.

In the printer 6 which supports direct printing based on one-to-one direct connection, a USB host controller 61 serving as a data link layer, a USB still image class driver 62 serving as a network layer, and a PTP driver 63 serving as a transport layer are present above the USB communication circuit 34 serving as a physical layer. Further, a print server 64 and a storage client 65 which serve as an application layer are present above the PTP driver 63.

The USB communication circuit 13 of the DSC 1 which supports direct printing based on one-to-one direct connection and the USB communication circuit 34 of the printer 6 which supports direct printing based on one-to-one direct connection can directly be connected using a USB cable 4.

Then, in the state of one-to-one connection of FIG. 5, the input device 19 of the DSC 1 is operated so that a printing instruction is outputted from the input device 19. Then, the print client 54 generates a start print request (a printing process instruction) for instructing the printing.

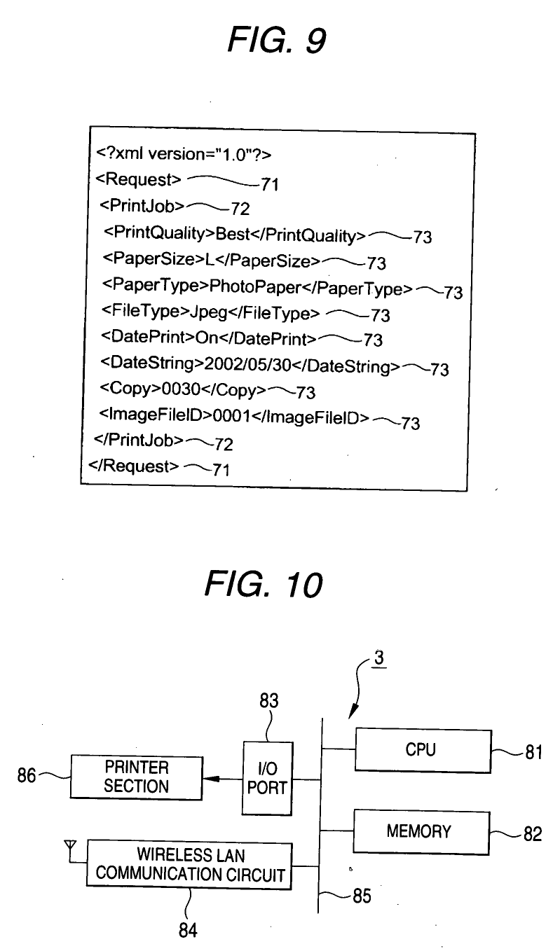

FIG. 9 is a diagram showing an example of a start print request generated by a print client 54. This start print request is a request described in an XML (eXtensibe Markup Language) format, and is treated as one text data file. Between a pair of tags 71 indicating a request, a pair of tags 72 are described for indicating that the request is a print job (a printing process). Further, between a pair of the tags 72 indicating a print job, text data pieces expressing the contents of the printing instruction are described in a state that each piece is located between a pair of tags 73 indicating an attribute. The start print request of the example of FIG. 9 instructs that image data of a JPEG format having a file ID (an identification number in one-to-one correspondence to the file name) of “0001” should be printed in 30 copies on photographic paper sheets of L size in the best quality together with a date stamp of “2002/05/30.” In this start print request, the file name of the DPOF data file 29 may be specified in place of the file ID of the image data file 28.

The start print request generated by the print client 54 of the DSC 1 is converted into communication data of the PTP standard by the PTP driver 53, and then converted into communication data of the USB standard by the USB still image class driver 52. The USB device controller 51 controls and causes the USB communication circuit 13 to transmit this communication data of USB standard to the USB cable 4.

The USB communication circuit 34 of the printer 6 connected directly to the DSC 1 by the USB cable 4 receives this communication data. The USB host controller 61 transfers to the USB still image class driver 62 the communication data received by the USB communication circuit 34 of the printer 6. The communication data is inverse-transformed into communication data of the PTP standard by the USB still image class driver 62, and then inverse-transformed into a start print request by the PTP driver 63 so as to be transferred to the print server 64. As a result, the start print request is transmitted from the print client 54 to the print server 64.

The print server 64 interprets the contents of the printing instruction of the start print request having been inverse-transformed.

Then, in the example of a start print request of FIG. 9, printing is instructed for an image based on an image data file 28 having a file ID “0001.” Thus, the print server 64 instructs the storage client 65 to acquire the image data file 28. The storage client 65 generates a get image file request for acquiring the image data file (an image data file having a file ID “0001” in the example of the figure) 28 necessary for the printing process.

The get image file request is described in an XML format. Between a pair of tags indicating a request, a pair of tags are described for indicating that the request is a get image file request. Between a pair of tags indicating the get image file request, text data (“0001” in the example of the figure) for the file ID of the image data file relevant to the acquisition is described between a pair of tags indicating an attribute.

The get image file request generated by the storage client 65 is transmitted as communication data from the USB communication circuit 34 to the USB cable 4 via the PTP driver 63 and the USB still image class driver 62 of the printer 6. This communication data is received by the USB communication circuit 13 of the DSC 1 connected directly to the printer 6 by the USB cable 4. The get image file request received by the USB communication circuit 13 is transferred to the storage server 55 via the USB still image class driver 52 and the PTP driver 53. As a result, the get image file request is transmitted from the storage client 65 to the storage server 55.

The storage server 55 interprets the contents of the get image file request. Then, the storage server 55 instructs the storage device 56 to perform a transmission process for the image data file (an image data file having a file ID “0001” in the example of FIG. 9) 28 relevant to the request. Under the management of the storage device 56, the image data of the image data file 28 relevant to the request is transmitted from the USB communication circuit 13 of the DSC 1 to the USB communication circuit 34 of the printer 6, and then stored as an image data file in the memory 32 of the printer 6. The transmission and the reception of the image data between the DSC 1 and the printer 6 are controlled by the PTP driver 53 of the DSC 1 and the PTP driver 63 of the printer 6.

Once the image data file is acquired in the memory 32, the print server 64 instructs the printer code generation section 66 to perform a printing process. According to the contents of the printing instruction of the start print request, the printer code generation section 66 generates a printer code for printing the image data of the image data file stored in the memory 32. This printer code is outputted through the I/O port 33 to the printer section 36. The printer section 36 executes the printing process according to the printer code.

As a result, the printer 6 outputs a printed document according to the contents of the printing instruction of the start print request. In the example of FIG. 9, 30 copies of image data of the JPEG format having the file ID “0001” are printed on photographic paper sheets of L size in the best quality together with a date stamp of “2002/05/30.”

In the start print request, when printing is instructed for a plurality of image data files, such as when the DPOF data file 29 is specified in place of the file ID of an image data file 28, the printer code generation section 66 may generate a printer code after the acquisition of all the image data files 28 has been completed. Nevertheless, in the case where the generation of the printer code is not started until the acquisition of all of a plurality of the image data files 28 is completed, it can take a long time before the printer code generation section 66 starts the generation of the printer code. Thus, the printer code generation section 66 preferably generates the printer code sequentially at each time when image data to be printed on one printer sheet, that is, image data of a minimum printing unit necessary for one printing action, is acquired. This reduces the waiting time in the printer code generation section 66, and thereby reduces the waiting time before the first sheet of the printed document is outputted from the printer 6 as well as a necessary time for the completion of the printing process in the printer 6.

As described above, when the DSC 1 which supports direct printing based on one-to-one direct connection is connected directly to the printer 6 which supports direct printing based on one-to-one direct connection, image data files saved in the DSC 1 can be printed out directly by the printer 6 without the intervention of a computer.

FIG. 10 is a block diagram showing the hardware configuration of a printer 3 which supports direct printing based on network connection in a network type direct printing system according to the present embodiment. One printer 3 comprises: a central processing unit 81; a memory 82; an I/O port 83; a wireless LAN communication circuit 84 for transmitting and receiving communication data by wireless; and a bus 85 for interconnecting these. The I/O port 84 is connected to a printer section 86 for performing a printing process onto paper, an OHP sheet, or the like according to a predetermined printer code.

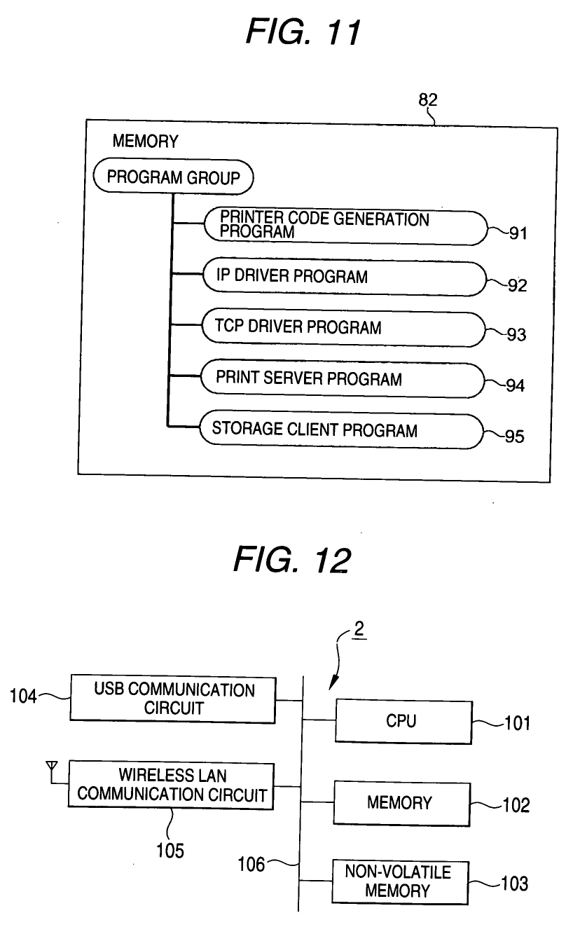

FIG. 11 is a diagram showing the storage contents of a memory 82 of FIG. 10. The memory 82 stores a program group. The program group of the memory 82 includes a printer code generation program 91, an IP (Internet Protocol) driver program 92, a TCP (Transmission Control Protocol) driver program 93, a print server program 94, and a storage client program 95.

The printer code generation program 91 is executed by the central processing unit 81 so as to realize a printer code generation section. On the basis of image data and its print setting information, the printer code generation section generates a printer code called an ESC/P command, or the like. This printer code is outputted through the I/O port to the printer section.

The IP driver program 92 is executed by the central processing unit 81 so as to realize an IP driver. The IP driver determines its own IP address according to a predetermined procedure, and then controls the transmission and the reception of communication data on the basis of the IP address. The IP address is an address for discriminating each communication unit, such as a printer and a computer, from other communication units on the network. Thus, the IP driver specifies an IP address of a destination communication unit into a destination. This communication data is transmitted by wireless from the wireless LAN communication circuit 84 to the wireless LAN 5. Further, the IP driver examines the destination of the communication data received by the wireless LAN communication circuit 84, and then receives the data when the destination agrees with its own IP address.

The TCP driver program 93 is executed by the central processing unit 81 so as to realize a TCP driver. The TCP driver controls the transmission and the reception of communication data on the basis of a port number.

The print server program 94 is executed by the central processing unit 81 so as to realize a print server for transmitting and receiving a request and a response concerning the control of the progress of a printing process or the printing process itself.

The storage client program 95 is executed by the central processing unit 81 so as to realize a storage client for transmitting and receiving a request and a response concerning the storage.

FIG. 12 is a block diagram showing the hardware configuration of a media conversion apparatus 2 in a network type direct printing system of FIG. 1. The media conversion apparatus 2 comprises: a central processing unit 101; a memory 102 for temporary storage; a non-volatile memory 103; a USB communication circuit 104 connected to a USB cable 4; a wireless LAN communication circuit 105 serving as network communication means for transmitting and receiving communication data by wireless; and a bus 106 for interconnecting these.

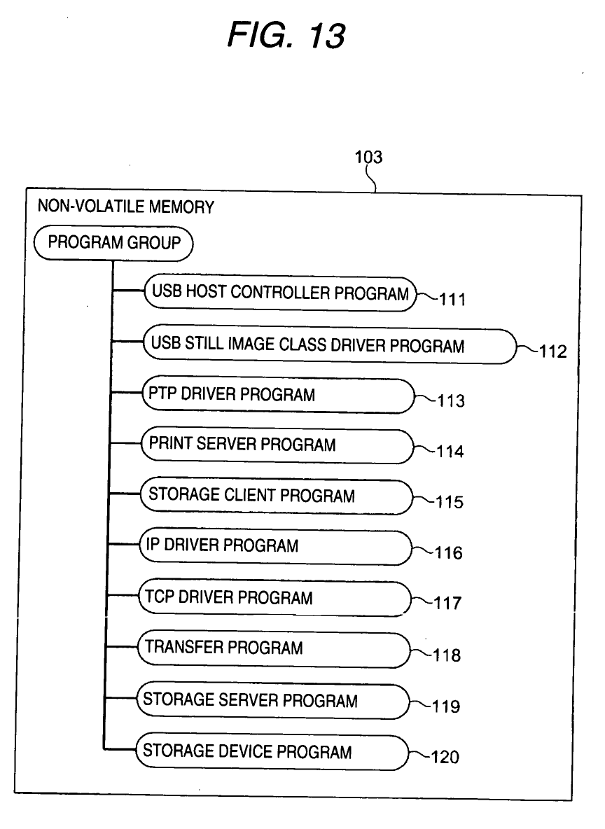

FIG. 13 is a diagram showing the storage contents of a non-volatile memory 103 of FIG. 12. The non-volatile memory 103 stores a program group. The program group of the non-volatile memory 103 includes a USB host controller program 111, a USB still image class driver program 112, a PTP driver program 113, a print server program 114, a storage client program 115, an IP driver program 116, a TCP driver program 117, a transfer program 118, a storage server program 119, and a storage device program 120.

The USB host controller program 111 is executed by the central processing unit 101 so as to realize a USB host controller. The USB still image class driver program 112 is executed by the central processing unit 101 so as to realize a USB still image class driver. The PTP driver program 113 is executed by the central processing unit 101 so as to realize a PTP driver. The print server program 114 is executed by the central processing unit 101 so as to realize a print server for transmitting and receiving a request and a response concerning the control of the progress of a printing process or the printing process itself, to and from the DSC 1. The storage client program 115 is executed by the central processing unit 101 so as to realize a storage client for transmitting and receiving a request and a response concerning the storage.

The IP driver program 116 is executed by the central processing unit 101 so as to realize an IP driver. The TCP driver program 117 is executed by the central processing unit 101 so as to realize a TCP driver. The transfer program 118 is executed by the central processing unit 101 so as to realize a transfer section for transmitting and receiving a request and a response concerning the control of the progress of a printing process or the printing process itself. The storage server program 119 is executed by the central processing unit 101 so as to realize a storage server for transmitting and receiving a request and a response concerning the storage. The storage device program 120 is executed by the central processing unit 101 so as to realize a storage device for performing an input and output process for the storage.

Described below is the operation at the startup of a network type direct printing system having the above-mentioned configuration.

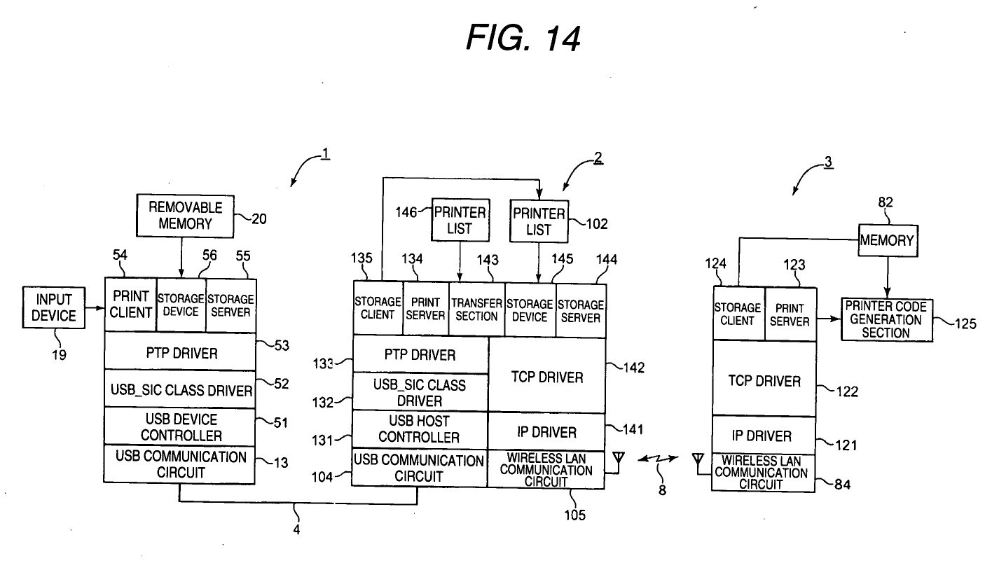

FIG. 14 is a diagram showing the stack structure of a communication protocol embodied in the connection state of FIG. 1, the power of a DSC 1 which supports direct printing based on one-to-one direct connection, the power of a media conversion apparatus 2, and the power of a printer 3 which supports network type direct printing are turned ON. The stack structure of communication protocol realized in the DSC 1 is the same as that of FIG. 8. Thus, the same reference numerals are used, and their description is omitted.

In the printer 3, an IP driver 121 and a TCP driver 122 are present above the wireless LAN communication circuit 84. A print server 123 and a storage client 124 which serve as an application layer are present above the TCP driver 122.

When started up, the IP driver 121 of the printer 3 performs first a predetermined process for determining its own IP address. Specifically, the started-up IP driver 121 selects, at first, one from a plurality of IP addresses assigned in advance. Then, the IP driver causes the wireless LAN communication circuit 84 to transmit a packet for checking whether the IP address is used or not. A broadcasting address is specified as the destination of this packet.

After that, when the wireless LAN communication circuit 84 does not receive any response packet after a predetermined time has elapsed, such as when no printer 3 is present in operation within the wireless communication zone of the wireless LAN communication circuit 84, the started-up IP driver 121 adopts the selected IP address as its own IP address.

In contrast, when a response packet is received, the started-up IP driver 121 re-selects another IP address from a plurality of the IP addresses assigned in advance, and then causes the wireless LAN communication circuit 84 to transmit a packet for checking whether the newly selected IP address is used or not. The started-up IP driver 121 repeats this selection and check process for the IP address, until an IP address is found that does not cause a response packet. Then, an IP address not used is adopted as its own IP address.

In the media conversion apparatus 2, a USB host controller 131, a USB still image class driver 132, and a PTP driver 133 are present above the USB communication circuit 104 connected to the DSC 1.

In the media conversion apparatus 2, an IP driver 141 and a TCP driver 142 are present above the wireless LAN communication circuit 105.

Further, in the media conversion apparatus 2, a print server 134 serving as receiving means, a storage client 135, a transfer section 143 serving as transferring means, a storage server 144, and a storage device 145 are present as an application layer above the PTP driver 133 and the TCP driver 142.

The IP driver 141 of the media conversion apparatus 2 performs a selection and check process for the IP address similar to that of the IP driver 121 of the printer 3, and thereby determines its own IP address. When the IP address of the IP driver 141 of the media conversion apparatus 2 is determined, the transfer section 143 performs an acquisition process for information concerning the printing capability of the printers 3 connected to the wireless LAN 5.

Specifically, the transfer section 143 generates a get capability request described in an XML format, and then transmits this get capability request to all the printers 3 connected to the wireless LAN 5. Printers 3 connected to the wireless LAN 5 can be detected using a discovery function of the IP driver 141 or the TCP driver 142. Then, the transfer section 143 transmits a get capability request individually to each printer 3 listed by the discovery function. When a printer 3 is not specified in advance, the transfer section 143 may transmit the get capability request to all the IP addresses recognized by the IP driver 141.

On receiving the get capability request, the print server 123 of each printer 3 transmits as a response the information concerning the printing capability of its own printer 3 which is stored in the memory 82 or the like in advance. This response is described as a text data file of XML format.

On receiving this response from the print server 123 of each printer 3, the transfer section 143 stores the information concerning the printing capability of each printer 3 (information concerning paper sheet sizes, paper types, the printing speed, image optimization options, printing layout, and the like available in the printing) contained in each response, into the memory 102 in the form of a printer list 146. In the printer list 146, the IP address, the information concerning the printing capability, and the like are coordinated for each printer 3.

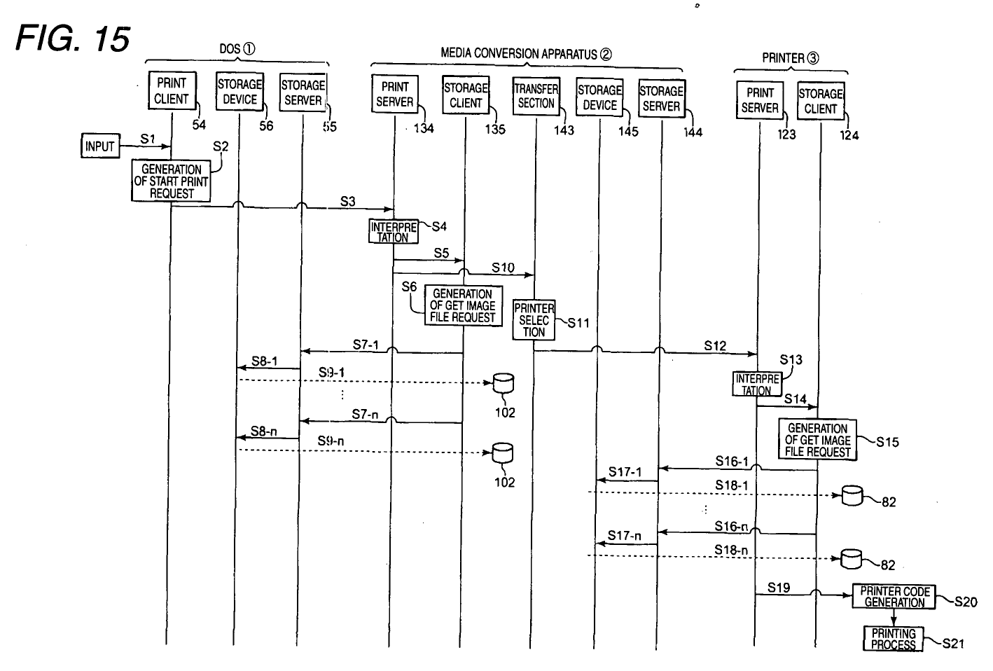

Described below is the printing operation of a network type direct printing system having the above-mentioned configuration. FIG. 15 is a diagram showing the printing process sequence of an entire network type direct printing system.

When an operation for a printing execution is made in the input device 19 of the DSC 1, a signal in response to this operation is provided from the input device 19 to the print client 54 (step S1). The print client 54 generates a start print request (step S2). The start print request is transmitted to the print server 134 of the media conversion apparatus 2 via the PTP driver 53, the USB still image class driver 52, and the USB communication circuit 13 of the DSC 1 and via the USB communication circuit 104, the USB still image class driver 132, and the PTP driver 133 of the media conversion apparatus 2 (step S3). As a result, the start print request is from the print client 54 of the DSC 1 transmitted to the print server 134 of the media conversion apparatus 2.

The print server 134 of the media conversion apparatus 2 interprets the contents of the printing instruction of the start print request (step S4). Then, the print server 134 instructs the storage client 135 to acquire an image data file necessary for the printing (step S5). The storage client 135 generates a get image file request for acquiring the image data file from the DSC 1 (step S6). The get image file request is transmitted from the storage client 135 to the storage server 55 of the DSC 1 (step S7-1 through step S7-n). The storage server 55 of the DSC 1 instructs the storage device 56 to transmit the image data file (step S8-1 through step S8-n). The storage device 56 of the DSC 1 transmits the image data file 28 to the media conversion apparatus 2. The image data file is stored in the memory 102 of the media conversion apparatus 2 (step S9-1 through step S9-n).

The print server 134 of the media conversion apparatus 2 transfers the start print request to the transfer section 143 (step S10). The transfer section 143 checks the contents of the printing instruction of the start print request, and then selects a printer 3 which is most suitable for performing the instructed printing process from among the printer list 146 (step S11).

Specifically, for example, the transfer section 143 selects a printer 3 that can perform the printing process of the printing instruction at the highest speed from among a plurality of printers 3 capable of performing the printing process.

When registering the information concerning the printing capability of the printers 3 into the printer list, the transfer section 143 may register also their order of priority. Then, when a plurality of printers 3 capable of performing the printing process specified in the start print request are registered in the printer list 146, one printer 3 may be selected according to the order of priority. This order of priority may be renewed through the input device 19 of the DSC 1, an input device (not shown) of the media conversion apparatus 2, a computer (not shown) connected to the wireless LAN 5, or the like. By virtue of this, the order of priority in the selection from a plurality of printers 3 can be set in accordance with each printing condition (that is, a combination of a grade, a size, an optimization option, and the like used in the printing)

In addition, when the model information (such as the serial number and the part number) or the vendor information of the DSC 1 are described in the start print request, the transfer section 143 may select in a higher priority a printer 3 of the same manufacturer.

Further, for example, simply on the basis of a part of the information in the start print request, the transfer section 143 may select a printer 3 that can perform the printing process at a high speed in accordance with the paper sheet specification and the printing quality specification in the start print request. Alternatively, on the basis of the correspondence between a user name of the DSC 1 and a user name of a printer 3 specified in advance, the transfer section may select a printer 3 such that these user names agree with each other. Further, log data such as the printing process time history of each printer 3 may be saved, and then the fastest printer 3 may be selected on the basis of this log. When a printer 3 is selected on the basis of the log of printing process time history, the fastest printer 3 under the actual connection environment through the network including the communication processing is selected in place of a printer 3 having a printer section 56 which is the fastest when operated as a stand alone. Further, when user names are compared, it may be configured that a printer 3 whose user name does not agree is not selected, on the contrary. This permits restricted selection of the printers 3.

The transfer section 143 transmits a start print request to the print server 123 of this printer 3 selected automatically (step S12). Specifically, the start print request transferred by the transfer section 143 is transmitted from the wireless LAN communication circuit 105 to the wireless LAN 5 via the TCP driver 142 and the IP driver 141 of the media conversion apparatus 2. The wireless LAN communication circuits 84 of a plurality of the printers 3 connected to the wireless LAN 5 receive the start print request wireless-transmitted from the wireless LAN communication circuit 105 of the media conversion apparatus 2. The IP driver 121 of each printer 3 checks the destination of the start print request received by the wireless LAN communication circuit 84. Then, when the IP address of the destination of the start print request agrees with its own IP address, the IP driver 121 transfers the start print request to the TCP driver 122. In contrast, when the IP address of the destination of the start print request does not agree with its own IP address, the IP driver 121 disposes the start print request. The TCP driver 122 transfers the start print request received from the IP driver 121 to the print server 123. As a result, the start print request generated by the print client 54 of the DSC 1 is transmitted through the media conversion apparatus 2 to the print server 123 of the printer 3 specified as the destination by the transfer section 143 of the media conversion apparatus 2.

The print server 123 of the printer 3 having received the start print request interprets the contents of the printing instruction of the start print request (step S13), and instructs the storage client 124 to acquire an image data file necessary for the printing (step S14). The storage client 124 generates a get image file request for acquiring the image data file (step S15). This get image file request is transmitted to the storage server 144 of the media conversion apparatus 2 (step S16-1 through step S16-n). The storage server 144 of the media conversion apparatus 2 instructs the storage device 145 of the media conversion apparatus 2 to transmit the image data file (step S17-1 through step S17-n). The storage device 145 of the media conversion apparatus 2 transmits the image data file to the printer 3. This image data file is stored in the memory 82 of the printer 3 (step S18-1 through step S18-n)

Once the image data file is acquired in the memory 82 of the printer 3, on the basis of the instruction of the print server 123 (step S19), the printer code generation section 125 generates a printer code (step S20). The printer section 86 performs the printing process according to the printer code (step S21).

As a result, the printer 3 which is specified as the destination of the start print request by the transfer section 143 and which supports direct printing based on network connection outputs a printed document in accordance with the contents of the printing instruction of the start print request generated by the DSC 1 which supports direct printing based on one-to-one direct connection. For example, when a start print request shown in FIG. 9 is generated by the DSC 1 which supports direct printing based on one-to-one direct connection, the printer 3 prints out 30 copies of image data of the file ID “0001” in a JPEG format in the best quality together with a date stamp of “2002/05/30” on photographic paper sheets of L size.

As described above, in this embodiment, the transfer section 143 of the media conversion apparatus 2 transfers the start print request generated by the DSC 1 which supports direct printing based on one-to-one direct connection to a printer 3 which supports direct printing based on network connection. Then, the printer 3 performs the printing process specified by the start print request. By virtue of this, when a DSC 1 (that is, a DSC 1 incapable of being directly connected to a network) which supports direct printing based on one-to-one direct connection solely is connected to the media conversion apparatus 2, images in image data files 28 saved in this DSC 1 can be printed out by a printer 3 which supports direct printing based on network connection.

The above-mentioned embodiments are examples of preferred embodiments of the invention. However, the invention is not limited to these, and various modifications and changes can be made.

In the above-mentioned embodiments, a unit for transferring a start print request and image data between the DSC 1 and a plurality of the printers 3 has been embodied in the media conversion apparatus 2 dedicated for the process solely. However, the unit for transferring them may be embodied in a general-purpose computer for executing an operating system program.

In the above-mentioned embodiments, a unit for feeding image data has been embodied in the DSC 1 having an image pick-up function. However, the image data feed unit may be: a storage unit without an image pick-up function; a player such as for an MO (Magneto-Optic) disk, a CD (Compact Disc), and a DVD (Digital Versatile Disk); a card reader such as for a portable flash memory; and an electronic device of various kinds such as a portable telephone.

In the above-mentioned embodiments, a unit for outputting image data has been embodied in the printer 3 for printing out image data. However, the image output unit may be a photograph frame type liquid crystal display device or another image display unit. Alternatively, the image output unit may be replaced by an image storage unit such as a network type file server for storing image data files. In this modification, a start print request is replaced by a start storage request (a save process instruction) for saving image data, while the printer list 146 is replaced by a storage list.

In the above-mentioned embodiments, the DSC 1 and the media conversion apparatus 2 have been connected through a USB cable 4. However, the DSC 1 and the media conversion apparatus 2 may be connected through: another type serial cable such as a telephone cable; a parallel cable such as a printer 3 cable; and a network cable such as an Ethernet (registered trademark) cable. Further, instead of cable connection, the DSC 1 and the media conversion apparatus 2 may be connected through a wireless communication line.

In the above-mentioned embodiments, the media conversion apparatus 2 and a plurality of the printers 3 have been connected through a wireless LAN. However, the media conversion apparatus 2 and a plurality of the printers 3 may be connected through a cable LAN. Further, the DSC 1 and the media conversion apparatus 2 may be connected through a wide area network such as the Internet. In this case, the IP address of this printer 3 registered in the printer list need not be the original IP address of this printer 3, and may be an IP address in one-to-one correspondence to the original IP address, that is, may be the IP address of a gateway device or the like of the Internet. By virtue of this, images taken at an athletic meet or the like can be printed out automatically by a printer of a relative living in a remote place or by a printer in a friend's home. As such, the invention allows every person to distribute photographs easily.

In the above-mentioned embodiments, the transfer section 143 of the media conversion apparatus 2 has selected a printer 3 of a destination when a start print request has been received. However, the transfer section 143 may select a printer 3 of a destination when the DSC 1 is connected.

In a media conversion apparatus, a network type direct output system, and a method for output process instruction transfer according to the invention, an image data file saved in an image feed unit can be transferred to an image output unit or an image recording unit via a network, so that an image based on the image data file can be outputted or the image data file can be stored.
FIG. 1
2 Media conversion apparatus
3 Printer
FIG. 2
12 Flash memory
13 USB communication circuit
14 I/O port
15 Card reader
17 Image pick-up section
18 Display device
19 Input device
20 Removable memory
FIG. 3
1 Flash memory
2 Program group
21 Image pick-up control program
22 USB device controller program
23 USB still image class driver program
24 PTP driver program
25 Print client program
26 Storage server program
27 Storage device program
FIG. 4
3 Removable memory
4 Data group
28 Image data file
29 DPOF data file
FIG. 5
6 Printer
FIG. 6
32 Memory
33 I/O port
34 USB communication circuit
36 Printer section
FIG. 7
1 Memory
2 Program group
41 Printer code generation program
42 USB host controller program
43 USB still image class driver program
44 PTP driver program
45 Print server program
46 Storage client program
FIG. 8
19 Input device
20 Removable memory
13 USB communication circuit
51 USB device controller
52 USB still image class driver
53 PTP driver
54 Print client
55 Storage server
56 Storage device
32 Memory
34 USB communication circuit
61 USB host controller
62 USB still image class driver
63 PTP driver
64 Print server
65 Storage client
66 Printer code generation section
FIG. 10
82 Memory
83 I/O port
84 Wireless LAN communication circuit
86 Printer section
FIG. 11
1 Memory
2 Program group
91 Printer code generation program
92 IP driver program
93 TCP driver program
94 Print server program
95 Storage client program
FIG. 12
102 Memory
103 Non-volatile memory
104 USB communication circuit
105 Wireless LAN communication circuit
FIG. 13
1 Non-volatile memory
2 Program group
111 USB host controller program
112 USB still image class driver program
113 PTP driver program
114 Print server program
115 Storage client program
116 IP driver program
117 TCP driver program
118 Transfer program
119 Storage server program
120 Storage device program 120
FIG. 14
19 Input device
20 Removable memory
13 USB communication circuit
51 USB device controller
52 USB_SIC class driver
53 PTP driver
54 Print client
55 Storage server
56 Storage device
104 USB communication circuit
131 USB host controller
132 USB_SIC class driver
133 PTP driver
134 Print server
135 Storage client
105 Wireless LAN communication circuit
141 IP driver
142 TCP driver
143 Transfer section
144 Storage server
145 Storage device
146 Printer list
102 Printer list
82 Memory
84 Wireless LAN communication circuit
121 IP driver
122 TCP driver
123 Print server
124 Storage client
125 Printer code generation section
FIG. 15
54 Print client
56 Storage device
55 Storage server
2 Media conversion apparatus
134 Print server
135 Storage client
143 Transfer section
145 Storage device
144 Storage server
3 Printer
123 Print server
124 Storage client
S1 Input
S2 Generation of start print request
S4 Interpretation
S6 Generation of get image file request
S11 Printer selection
S13 Interpretation
S15 Generation of get image file request
S20 Printer code generation
S21 Printing process

What is claimed is:

1. A media conversion apparatus comprising:
one-to-one communication means connected to an image feed unit capable of being connected directly to an image output unit by one-to-one correspondence;
receiving means for receiving via the one-to-one communication means an output process instruction outputted from the image feed unit for causing the image output unit to perform a desired output;
network communication means connected to a plurality of network type image output units capable of performing via a network an output process based on the output process instruction; and
transferring means for selecting one from a plurality of the network type image output units and then transmitting the output process instruction received by the receiving means to the selected network type image output unit via the network communication means.

2. A media conversion apparatus according to claim 1, wherein the transferring means compares an output process instruction received by the receiving means with information concerning output capability of a plurality of the network type image output units connected to the network communication means, then selects a network type image output unit from a plurality of the network type image output units, and then transmits the output process instruction received by the receiving means to the selected network type image output unit.

3. A media conversion apparatus according to claim 2, wherein the transferring means collects the information concerning the output capability of a plurality of the network type image output units in advance, then generates a list of the information, and then selects one network type image output unit from the list when the receiving means receives an output process instruction.

4. A media conversion apparatus according to claim 3, wherein in the list, order of priority depending on output conditions is assigned to a plurality of the network type image output units, and wherein
the transferring means selects one having the highest order of priority from a plurality of the network type image output units having an output condition most suitable to an output process instruction received by the receiving means.

5. A media conversion apparatus according to claim 4, wherein the order of priority can be changed by an input device of the image feed unit, a computer connected to the network, or an input device of the media conversion apparatus.

6. A media conversion apparatus according to claim 2, wherein on the basis of the information concerning the output capability of each network type image output unit, from a plurality of the network type image output units, the transferring means selects one expected to process at the highest speed an output process instruction received by the receiving means, one purchased from the same vendor as that of the image feed unit, one used by the same user as that of the image feed unit, or one having the shortest output process time in the past.

7. A network type direct output system comprising:
a media conversion apparatus according to any one of claims 1 through 6;
an image feed unit connected to the one-to-one communication means of the media conversion apparatus and transmitting to the one-to-one communication means an output process instruction for causing an image output unit connected directly to the image feed unit by one-to-one correspondence to perform a desired output; and
a network type image output unit connected to the network communication means of the media conversion apparatus via a network and performing an output process of the output process instruction transmitted from the image feed unit via the media conversion apparatus.

8. A method for output process instruction transfer comprising the steps of:
receiving an output process instruction transmitted for causing an image output unit to perform a desired output from an image feed unit capable of being connected directly to the image output unit by one-to-one correspondence;
selecting one from a plurality of network type image output units connected via a network and capable of performing an output process based on the output process instruction; and
transmitting to the selected network type image output unit the output process instruction received from the image feed unit.

9. A media conversion apparatus comprising:
one-to-one communication means connected to an image feed unit capable of being connected directly to an image storage unit by one-to-one correspondence;
receiving means for receiving via the one-to-one communication means a save process instruction outputted from the image feed unit for causing the image storage unit to perform a desired save;
network communication means connected to a plurality of network type image storage units capable of performing via a network a save process based on the save process instruction; and transferring means for selecting one from a plurality of the network type image storage units and then transmitting a save process instruction received by the receiving means to the selected network type image storage unit via the network communication means.
